(19) United States
(12) Patent Application Publication
(10) Pub. No.: US 2008/0130987 A1
(43) Pub. Date: Jun. 5, 2008

(54) Color Management of RAW Content from Digital Capture Devices

(75) Inventor: Michael D. Stokes, Eagle, ID (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/565,462

(22) Filed: Nov. 30, 2006

(51) Int. Cl. G06K 9/00

(52) U.S. Cl. 382/162; 382/276

(57) ABSTRACT

Various embodiments provide for the ability to convert back and forth between a RAW image file and a processed image file by associating metadata with the processed image file. The metadata is useable to effect conversion between and amongst image files. In addition, in at least some embodiments, a processing pipeline incorporates functions to access proprietary extensions to convert back and forth between RAW image files and processed image files using the associated metadata.

### BACKGROUND

Many digital cameras and other types of digital image capturing devices capture an image and create, from the image, a proprietary or native format image file referred to herein as a “RAW” image file. Examples of RAW image formats available in the marketplace today include: Canon Raw Format (crw), Nikon Electronic Format (nef), and Adobe Digital Negative Format (dng). RAW image files are so named because a RAW image file typically contains nearly all of the data captured by the camera sensor and has not yet been processed for white balance, contrast, sharpness, saturation, and dynamic range. Accordingly, a RAW image file is not yet ready to be used by various graphic editors, printers, or other applications. That is, typically a RAW image file is one that is understood only by the type of image capturing device that captured the image or a small number of like or similar devices. Accordingly, before a RAW image file can be manipulated or further processed by other components such as those named above, it must typically be processed and converted from the RAW image file into an image format (such as JPEG, TIFF and the like) that is recognized by these other components. This conversion can be carried out on the digital image capturing device itself, or by software after the RAW image file has been downloaded from the device to a computer.

Unfortunately, once a RAW image file is processed and converted into a different image format, it is typically very difficult if not impossible to convert back to the RAW image file without creating a visible loss in image quality.

As professional photographers and others want more and more control over their content and their work, it is becoming increasingly desirable for photographers and others to have access to the RAW image file in order to ensure that their images are not unintentionally changed.

### SUMMARY

Various embodiments provide for the ability to convert back and forth between a native or proprietary (i.e. RAW) image file and a image file processed or rendered for output by associating metadata with the processed image file. The metadata is useable to effect reversible conversion between and amongst image files.

In at least some embodiments, the processed image file can maintain bit precision, white point control, and dynamic range when converted from a RAW image file to the processed image file. In at least some embodiments, the associated metadata identifies algorithm(s) and parameters that were used to convert the RAW image file into the processed image file. Therefore, the resulting processed image file along with the associated metadata can be used to convert the processed image file back into the original RAW image file.

In addition, in at least some embodiments, a processing pipeline incorporates functions to access proprietary extensions to convert back and forth between RAW image files and processed image files using the associated metadata.

### BRIEF DESCRIPTION OF THE DRAWINGS

FIG. 1 illustrates a system for using a RAW image file in accordance with one embodiment.

FIG. 2 illustrates an exemplary image file that can be converted back into a RAW image file.

FIG. 3 illustrates an exemplary processing pipeline used to convert a RAW image file into a processed image file with associated metadata.

FIG. 4 illustrates a flow diagram that describes steps in a method in accordance with one embodiment.

### DETAILED DESCRIPTION

Overview

Various embodiments provide for the ability to convert back and forth between a native or proprietary (i.e. RAW) image file and a processed image file by associating metadata with the processed image file. The metadata is useable to effect conversion between and amongst image files.

In at least some embodiments, the processed image file maintains bit precision, white point control and dynamic range when converted from a RAW image file to the processed image file. In at least some embodiments, the associated metadata identifies algorithm(s) and parameters that were used to convert the RAW image file into the processed image file. Thus, using the processed image file and the associated metadata, the processed image file can be converted back into the original RAW image file.

As some background, consider that in the past, converting a RAW image file into a processed image file that could be used by graphics editors and other applications, such as JPEG or TIFF, often resulted in the loss of data which was a manifestation of the conversion algorithm used for conversion. This loss of data is known as a compression artifact. There are three common types of compression artifacts that tend to occur when converting a RAW image file into a processed image file: (1) loss of bit precision; (2) loss of white point control flexibility; and (3) loss of dynamic range. The loss of data due to compression artifacts makes it difficult if not impossible to convert the processed image file back into the original RAW image file.

Processed image files are associated with a color space relative to which the file can be rendered. Some color spaces tend to not create compression artifacts during file conversions. These color spaces are referred to herein as “capable” color spaces. Processed image files associated with capable color spaces are referred to herein as capable processed image files.

It is effectively impossible to convert even a capable processed image file back into the original. RAW image file without knowing the algorithms and parameters that were used to convert the RAW image file into the processed image file. In the past, this information has often been discarded during the file conversion. However, in cases where this information has been saved, it has been necessary to also save the original RAW image file. Saving the original RAW image file is undesirable because it is inconvenient and takes up space.

The embodiments described in more detail below provide more control over content by allowing conversion back and forth between RAW image files and various processed image files. In at least some embodiments, this takes place by enabling access to information (e.g. metadata) that describes the algorithm(s) and associated parameters that were used to convert the RAW image file into a processed image file. By knowing the particular algorithms and associated parameters, steps can be taken to back-convert a processed image file to its original RAW image file.

### Exemplary Embodiment

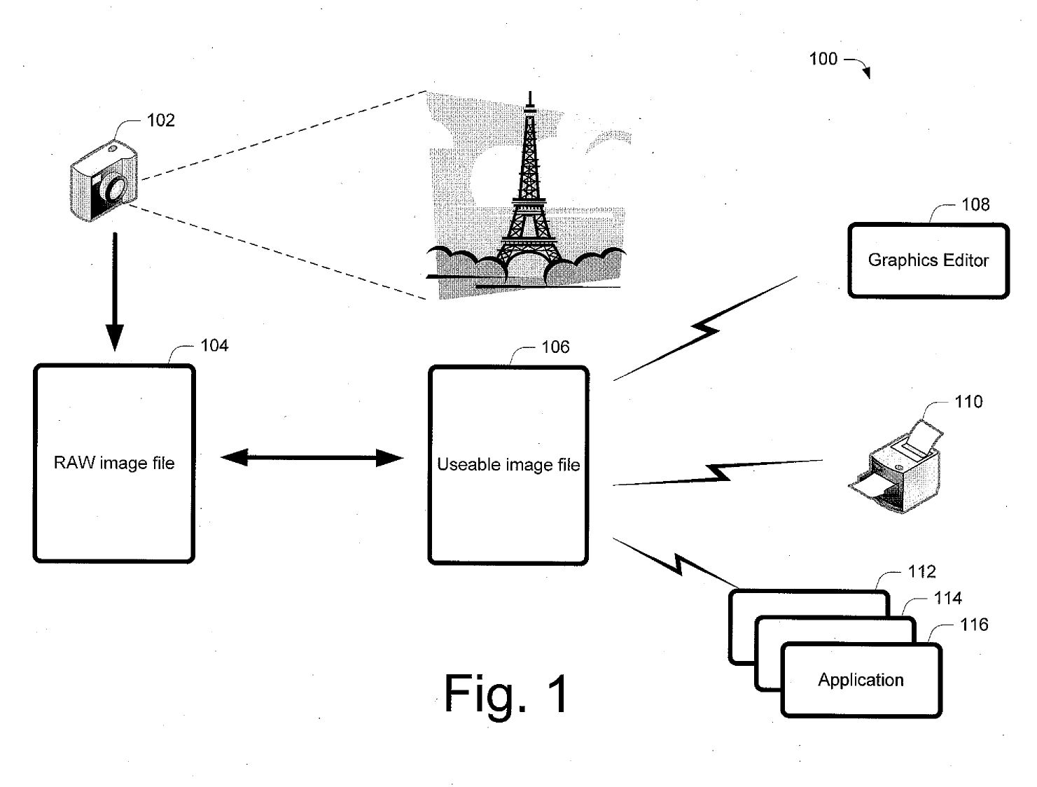

FIG. 1 illustrates, generally at 100, a system in accordance with one embodiment. System 100 includes a digital image capturing device 102, a RAW image file 104 produced by device 102, a useable image file 106 which is useable by such devices as a graphics editor 108, printer 110, and various applications 112, 114, and 116.

Digital image capturing device 102 may be any device that is capable of capturing a digital image. Typically, such capturing devices include a processor, one or more computer-readable media, and computer-readable instructions that are executable by the capturing device to implement its functionality. Examples of suitable digital image capturing devices include, but are not limited to, digital cameras, camera phones and the like. Digital image capturing device 102 captures an image and creates a RAW image file from each captured image. As noted above, a RAW image file constitutes a native file format that is produced by and understood only by the capturing device or a small number of like devices. The RAW format is typically not understood by a wide variety of off-device components that can eventually process the associated image. There are simply hundreds of such native file formats. Typically, because the RAW image file is not understood by other devices other than its capture device, it is not yet processed and in a form such that it can be used by various graphic editors, printers, or other applications.

In order to be useable by other devices such as graphics editors, printers, and other applications, RAW image file 104 may be and typically is converted into a useable image file 106. This conversion may occur on the digital image capturing device itself or on a computing device apart from the capturing device. The useable image file is typically in a format (such as JPEG, TIFF and the like) that is suitable for use by graphics editor 108, printer 110, and applications 112, 114, and 116.

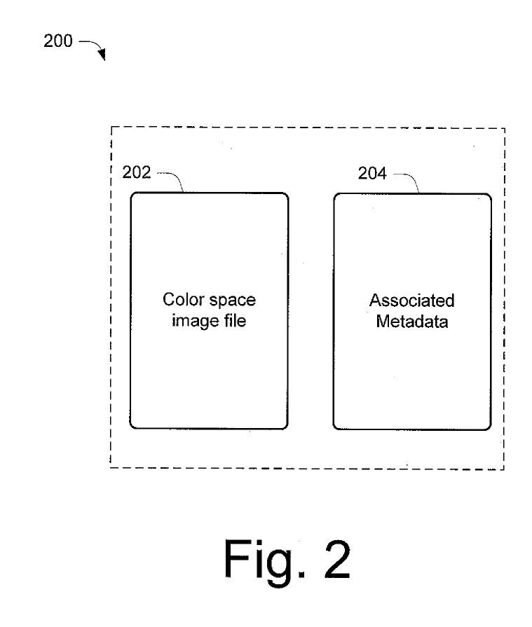

FIG. 2 illustrates, generally at 200, an image file in accordance with one embodiment. Image file 200 is configured to be converted back into the RAW image file from which it was originally converted. In this particular example, the image file includes a processed image file 202 and associated metadata 204.

In at least some embodiments, processed image file 202 can be associated with any one of a number of different color spaces relative to which the file can be rendered. In some embodiments, a capable processed image file utilizes a 16-bit color space format. However, with 16 bits there may be a likelihood of some bit precision loss when converting from a RAW image file to a processed image file. Therefore, in at least some embodiments, a capable processed image file can utilize a 24 to 32-bit color space format. In at least one embodiment, the color space format of a capable processed image file comprises scRGB, which is an extension of Standard Red Green Blue (sRGB). scRGB is a 32 bit-per-channel floating point with a d65 whitepoint and a 1.0 gamma, as will be appreciated by the skilled artisan.

In the illustrated and described embodiment, associated metadata 204 identifies one or more algorithms and parameters associated with the algorithms that were used to convert the RAW image file into processed image file 202. Accordingly, associated metadata 204 enables the ability to convert processed image file 202 back into the original RAW image file. That is, by identifying and knowing the algorithms that were utilized to effect conversion from the RAW image file to the processed image file, effective conversion techniques can be employed to back-convert the processed image file to the RAW image file.

An example of this would be to include the algorithms and parameters for those algorithms to convert a sensor image from its mosaic format into a capable working space. In this embodiment, by way of example and not limitation, a typical process would include using a demosaic algorithm to convert a captured image to an RGB image, and then white balancing the RGB image using some chromatic adaptation solutions, such as CIECAT02, and a dynamic range compression such as a sigmoidal compression. By first converting to floating point and increasing bit precision all of these conversions may be applied and then inverted without data or quality loss.

Metadata 204 may be associated with processed image file 202 in a number of different ways. In one embodiment, associated metadata can be linked to processed image file 202 so that when it is desired to convert back to the RAW image file, the link can be followed to access the appropriate information or metadata to back-convert the file. Alternately or additionally, the associated metadata 204 can comprise a physical part of image file 200.

It is to be appreciated that the image file, depicted at 200, can be used by graphics editors and other applications without losing the ability to be converted back into the original RAW image file. This gives photographers and others the ability to edit and modify their image files while still maintaining the ability to convert back into the original RAW image file.

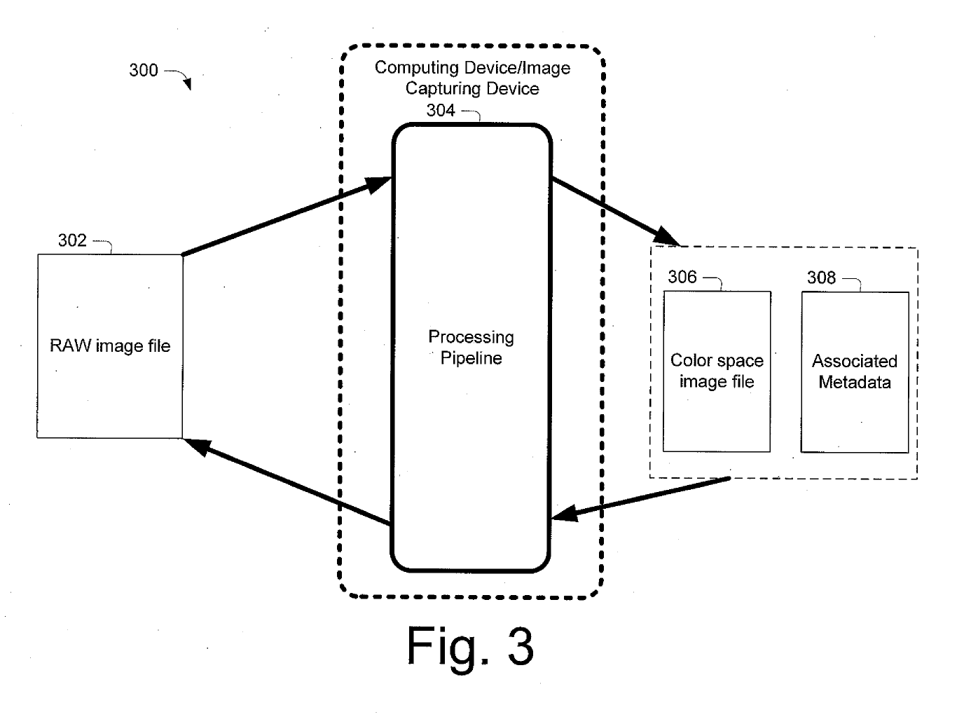

FIG. 3 illustrates, generally at 300, an exemplary processing pipeline used to convert a RAW image file into a processed image file that includes or otherwise references associated metadata. Here, RAW image file 302 can be received and processed by processing pipeline 304. Processing pipeline 304 can include any suitable image-processing components including proprietary conversion components or extensions (such as those provided by camera manufacturers) for processing the RAW image file into a processed image file.

After receiving RAW image file 302, processing pipeline 304 outputs processed image file 306 and associated metadata 308. As noted above, this metadata describes the algorithm(s) and associated parameters that were used to effect conversion to the processed image file. This can include, for example, metadata references that describe proprietary conversion extensions, back-conversion algorithms and the like. Notice also, that the process of using the processing pipeline to convert RAW image file 302 into processed image file 306 and associated metadata 308 is reversible. Accordingly, processed image file 306 and associated metadata 308 can be sent back to processing pipeline 304. After receiving processed image file 306 and associated metadata 308, the processing pipeline and its associated components can ascertain, from the metadata, the algorithms), parameters or extensions that were used to effect conversion to the processed image file. Once this information has been ascertained, processing pipeline 304 can process the processed image file and output RAW image file 302. Accordingly, the processing pipeline allows for the conversion back and forth between a RAW image file and a processed image file.

In one or more embodiments, metadata may include, by way of example and not limitation, a set of binaries or references to binaries that can be loaded and executed as well as the parameters to input into them. In one or more embodiments, by way of example and not limitation, a typical set of binaries may include a device model conversion to CIEXYZ, an appearance model conversion to perceptual space, and then conversion to scRGB using a standard viewing condition.

Processing pipeline 304 may reside at any location that is suitable for converting back and forth between a RAW image file and a processed image file with associated metadata. In one embodiment, processing pipeline 304 can reside on a computing device, such as a user's computer, to enable the user to convert back and forth between RAW image files and processed image files with associated metadata. Additionally or alternatively, processing pipeline 304 may reside on an image capturing device itself so that when a user downloads an image to his computer, the image has already been converted into processed image file 306 and includes the associated metadata. Such computing devices and image capturing devices include one or more processors, one or more computer-readable media (such as ROM, RAM, flash memory, hard disk and the like), and computer-readable instructions that are executable by the processor(s). It is to be appreciated an understood that processing pipeline can be implemented in any suitable hardware, software, firmware or combination thereof

Exemplary Method

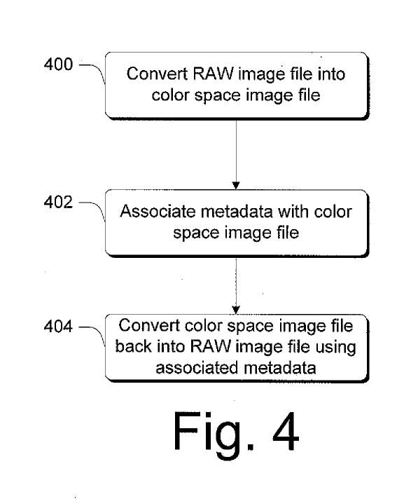

FIG. 4 is a flow diagram that describes steps in a method in accordance with one embodiment. The method can be implemented in connection with any suitable hardware, software, firmware or combination thereof In at least some embodiments, the method can be implemented in connection with systems, such as those systems shown and described above.

At 400, a RAW image file is converted into a processed image file. The RAW image file, as discussed above, can be any type of RAW image file. In at least some embodiments, the processed image file is associated with a capable color space format relative to which the file can be rendered, such as scRGB. However, other color space formats may be used without departing from the spirit and scope of the claimed embodiments.

At 402, metadata is associated with the processed image file. The metadata, as described above, may include the algorithms (or references to the algorithms) and parameters that were used to convert from the RAW image file to the processed image file. In at least some, embodiments, the associated metadata may be a physical part of the processed image file. Alternately or additionally, the associated metadata may be linked to the processed image file in some way, such as by having the processed image file include a pointer to the associated metadata. As discussed above, the processed image file is suitable for use by other applications, such as graphic editors and printers.

At 404, the processed image file is converted back into the RAW image file using the associated metadata. In at least some embodiments, a processing pipeline uses the associated metadata as well as proprietary extensions to convert the processed image file back into the RAW image file.

Conclusion

Various embodiments provide for the ability to convert back and forth between a native or proprietary (i.e. RAW) image file and a processed image file by associating metadata with the processed image file. The metadata is useable to effect conversion between and amongst image files. In addition, in at least some embodiments, a processing pipeline incorporates functions to access proprietary extensions to convert back and forth between RAW image files and processed image files using the associated metadata.

Although the invention has been described in language specific to structural features and/or methodological steps, it is to be understood that the invention defined in the appended claims is not necessarily limited to the specific features or steps described. Rather, the specific features and steps are disclosed as preferred forms of implementing the claimed invention.

1. A method comprising:
converting a RAW image file into a processed image file; and
associating metadata with the processed image file, wherein the metadata is configured to enable the processed image file to be converted back into the RAW image file.

2. The method of claim 1, wherein the processed image file utilizes a color space format having at least 16 bits.

3. The method of claim 1, wherein the processed image file utilizes a scRGB color space format.

4. The method of claim 1, wherein the act of associating comprises including the metadata as part of the processed image file.

5. The method of claim 1, wherein the act of associating comprises linking the metadata to the processed image file.

6. The method of claim 1, wherein the metadata includes at least a reference to a conversion algorithm and associated parameters used to convert from the RAW image file to the processed image file.

7. The method of claim 1 wherein the acts of converting and associating are performed by a processing pipeline that resides on an image capturing device that captured an associated image.

8. The method of claim 1, wherein the acts of converting and associating are performed by a processing pipeline that does not reside on an image capturing device that captured an associated image.

9. One or more computer readable media having computer-readable instructions thereon which when executed implement a method comprising:
converting a RAW image file into a processed image file using a conversion algorithm;
associating metadata with the processed image file, wherein the metadata is configured to allow the processed image file to be converted back into the RAW image file; and
converting the processed image file back into the RAW image file.

10. The one or more computer-readable media of claim 9, wherein the processed image file utilizes a color space format having at least 16 bits.

11. The one or more computer-readable media of claim 9, wherein the processed image file utilizes a scRGB color space format.

12. The one or more computer-readable media of claim 9, wherein the act of associating comprises including the metadata as part of the processed image file.

13. The one or more computer-readable media of claim 9, wherein the act of associating comprises linking the metadata to the processed image file.

14. The one or more computer-readable media of claim 9, wherein the metadata includes at least a reference to a conversion algorithm that was used to convert from the RAW image file to the processed image file.

15. The one or more computer-readable media of claim 9 embodied on an image capturing device.

16. The one or more computer-readable media of claim 9 embodied on a computing device.

17. An image capturing device comprising:
a processor;
a computer readable medium comprising computer readable instructions which, when executed by the processor, causes the image capturing device to:
capture a digital image;
create a RAW image file from the captured digital image, wherein the RAW image file is a format that is native to the image capturing device;
convert the RAW image file into a processed image file that can be processed by other devices; and
associate metadata with the processed image file, wherein the metadata is configured to allow the processed image file to be converted back into the RAW image file.

18. The image capturing device of claim 17 embodied as a digital camera.

19. The image capturing device of claim 17, wherein the processed image file utilizes an scRGB color space format.
